(19) United States
(12) Patent Application Publication
(10) Pub. No.: US 2016/0099522 A1
(43) Pub. Date: Apr. 7, 2016

(54) CONNECTOR

(71) Applicant: Yazaki Corporation, Tokyo (JP)

(72) Inventors: Shogo SUZUKI, Makinohara-shi (JP); Masayuki SAITOH, Makinohara-shi (JP)

(73) Assignee: YAZAKI CORPORATION, Tokyo (JP)

(21) Appl. No.: 14/874,751

(22) Filed: Oct. 5, 2015

(30) Foreign Application Priority Data
Oct. 6, 2014 (JP) 2014-205927

(51) Int. Cl. H01R 13/648; H01R 13/502

(52) U.S. Cl. CPC H01R 13/648; H01R 13/502

(57) ABSTRACT

A connector includes a housing that holds a terminal having a first portion and a second portion. The second portion of the terminal includes a grounding terminal assembling part to which a grounding terminal provided at a distal end of a grounding line is assembled, and an assembling angle at which the grounding terminal is assembled to the grounding terminal assembling part is set so that the grounding line extends to be gradually away from a side surface of the housing.

### CROSS REFERENCE TO RELATED APPLICATIONS

This application claims a benefit of Japanese Patent Application (No. 2014-205927) filed on Oct. 6, 2014, the contents of which are incorporated herein by reference.

### BACKGROUND OF THE INVENTION

1. Technical Field

The present invention relates to a grounding structure of a connector in which a terminal of a grounding line is assembled to a terminal portion which is exposed outside a housing.

2. Related Art

A connector is known (for example, refer to JP-A-2013-247053) which includes a female terminal housing that is formed with a plurality of terminal accommodating rooms into which a plurality of female terminals can be inserted respectively, and a male terminal housing which holds a plurality of male terminals which are connected to the plurality of female terminals. The female terminal housing and the male terminal housing are separately formed, and when these housings are engaged to be assembled to each other, the respective terminals are electrically connected.

In the connector described in JP-A-2013-247053, the female terminal is formed into a pipe-like shape by containing an elastically deformable contact member, and when a lance formed with an elastic member on the inner wall of the terminal accommodating room is engaged in a locking hole which is formed on one side surface of the pipe-like female terminal, the female terminal is retained.

Since the female terminal is inserted into the terminal accommodating room in this way, and the female terminal housing and the male terminal housing are engaged progressively at a first location where the lance is engaged, and at a second location where the male terminal slides on and is electrically connected with the contact member of the female terminal which is engaged with the lance, the maximum insertion force when the female terminal and the male terminal are connected can be reduced.

For the connector described in JP-A-2013-247053, the male terminal is connected to a conductor portion (bus bar), which the male terminal housing is provided with and which is exposed outside, in the male terminal housing, and a grounding is performed by further connecting a grounding line to the bus bar. A grounding terminal is provided at the distal end of the grounding line, and is adapted to be assembled to a grounding terminal assembling part which the bus bar is formed with.

For the connector described in JP-A-2013-247053, the grounding terminal assembling part is assembled to the grounding terminal from a direction perpendicular to the extending direction of the grounding line, and while the grounding terminal has been assembled to the grounding terminal assembling part, the grounding line extends in parallel with the side surface of the male terminal housing. Therefore, if the space between the grounding line and the side surface of the male terminal housing is small, the connecting part where the grounding line and the grounding terminal are connected may hit the side surface of the male terminal housing because a swing or the like.

In this case, by shifting the position of the grounding terminal assembling part to expand the distance between the connecting part and the side surface, for example, by making the grounding terminal assembling part project from the bus bar to such an extent that the connecting part and the side surface will not hit each other, a collision of the connecting part and the side surface can be prevented. However, for example, when the grounding terminal assembling part is projected as expected, the bus bar becomes larger accordingly, and it may become difficult to downsize the bus bar and eventually downsize the connector.

The object of the present invention is to provide a connector which can avoid a collision of the grounding line and the housing.

### SUMMARY

According to an aspect of the invention, a connector includes a housing that holds a terminal having a first portion and a second portion, the first portion being embedded in the housing, the second portion being exposed outside the housing. The second portion of the terminal includes a grounding terminal assembling part to which a grounding terminal provided at a distal end of a grounding line is assembled, and an assembling angle at which the grounding terminal is assembled to the grounding terminal assembling part is set so that the grounding line extends to be gradually away from a side surface of the housing.

According to this, because it is possible to make the grounding line gradually away from the side surface of the housing, and extend while a sufficient space is kept, even if the grounding line swings, it can be prevented that the grounding line hits the side surface of the housing. Therefore, it is not necessary to make the grounding terminal assembling part greatly project from the terminal to shift the position of the terminal, to avoid a collision of the grounding line and the housing, and it is possible to downsize the terminal and the grounding terminal and eventually downsize the connector, in response to the assembling angle of the grounding terminal.

In this case, it is possible to form the grounding terminal assembling part by making the assembling direction of the grounding terminal substantially perpendicular to the extending direction of the grounding line. Thereby, by inclining the assembling direction of the grounding terminal to the grounding terminal assembling part at an assembling angle, it is possible to make the grounding line whose grounding terminal is assembled to the grounding terminal assembling part extend to incline from the side surface of the housing at an inclination angle corresponding to the assembling angle of the grounding terminal, and spaced gradually from the side surface.

According to the present invention, a connector which can avoid a collision of a grounding line and a housing can be implemented.

### BRIEF DESCRIPTION OF DRAWINGS

FIG. 1 is a perspective view which indicates the whole constitution of a connector of one embodiment of the present invention by separating a male terminal housing and a female terminal housing.

FIG. 2 is a figure which indicates the connector of the embodiment of the present invention from above.

FIG. 3 is a figure which indicates that a grounding terminal of a grounding line is assembled to a grounding terminal assembling part of the connector of the embodiment of the present invention.

FIG. 4 is a figure which indicates the connector in which a rotation preventing part of a terminal is inclined.

### DETAILED DESCRIPTION OF EMBODIMENTS

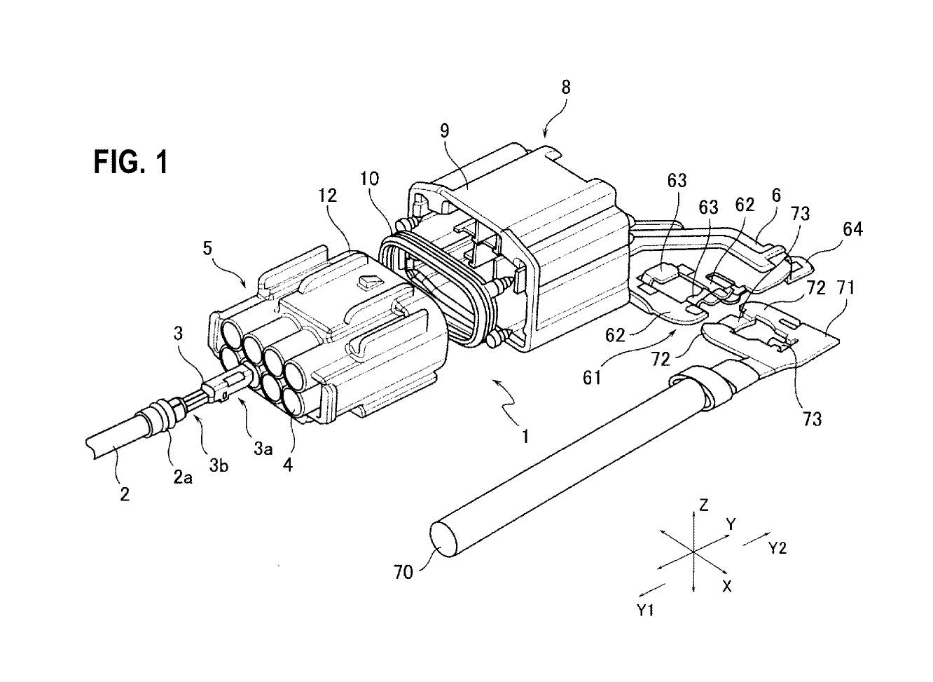

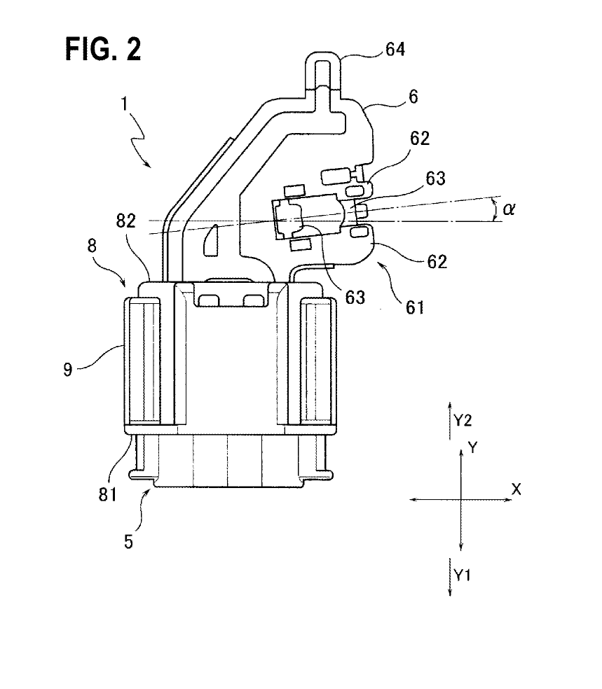

A connector of the present invention is described with reference to the attached figures as follows. FIGS. 1 and 2 are perspective views which indicate the constitution of a connector 1 of one embodiment of the present invention. In the following description, the arrow X directions shown in FIGS. 1 and 2 are rightward/leftward directions, the arrow Y directions are forward/backward directions, and the arrow Z directions are upward/downward directions. In these fonvard/backward directions, the arrow Y1 directions in FIGS. 1 and 2 are forward (front), and the arrow Y2 directions are backward (back). However, these rightward/leftward directions, forward/backward directions, and upward/downward directions may not necessarily correspond with the real directions at the time of implementation.

As shown in FIGS. 1 and 2, the connector 1 includes a female terminal housing 5 which is formed with a plurality of terminal accommodating rooms 4 into which female terminals 3 may be inserted respectively, and a male terminal housing 8 which holds a plurality of male terminals (not shown) which are connected to the female terminals 3, and when the female terminal housing 5 and the male terminal housing 8 are engaged in the forward/backward direction, the female terminals 3 and the male terminals are connected. Both the female terminal housing 5 and the male terminal housing 8 are molded of resin.

The female terminal 3 is formed to include a contact part 3a which is formed into a pipe shape to contain a contact member that is elastically deformable, and a crimped terminal part 3b to which an electric wire 2 is crimped. A waterproof stopper 2a is mounted to the periphery of the end of the electric wire 2. The terminal accommodating room 4 of the female terminal housing 5 is formed to include a rectangular pipe-like accommodating room (hereinafter referred to as rectangular pipe part) in which the contact part 3a of the female terminal 3 is accommodated, and a cylindrical accommodating room (hereinafter referred to as cylindrical pipe part) in which the crimped terminal part 3b and the waterproof stopper 2a of the electric wire 2 are accommodated. The rectangular pipe part is located closer to the male terminal housing 8 than the cylindrical pipe part, and the inserted female terminal 3 is locked and retained with, for example, a lance (a cantilever-like spring piece) which the inner wall of the rectangular pipe part is formed with.

Although not particularly illustrated, a plurality of male terminals which are inserted into and connected with the female terminals 3 are insert-molded and held in the male terminal housing 8. For example, the male terminals are made of board-like conductors, the distal ends of the male terminals relatively enter into the rectangular part of the terminal accommodating room 4 of the female terminal housing 5, and the male terminals are formed to be slidably connected with the contact members of the female terminals 3. The male terminal housing 8 is formed with a body part 9 to cover a female hood 12 of the female terminal housing 5. Between the body part 9 and the female hood 12, a ring-like sealing member (for example, a waterproof packing) 10 is mounted, and the connecting part of the male terminals and the female terminals 3 is prevented from being inundated.

These male terminals are adapted to be connected to a bus bar 6 which is held in the male terminal housing 8, and connected to a grounding line 70 through the bus bar 6. The bus bar 6 is formed by bending a metal plate having conductivity. The bus bar is insert-molded into the male terminal housing 8 so that the connection part where the bus bar 6 is connected with the male terminals is embedded in the male terminal housing 8, and the other part of the bus bar 6 except the above part is exposed from the male terminal housing 8. The bus bar 6 may be molded integrally with the male terminals, and may be molded separately if the bus bar 6 is held in the male terminal housing 8 while being connected to the male terminals electrically. The part exposed from the male terminal housing 8 is described as the bus bar 6 in the following.

The bus bar 6 extends into a flat board shape from an end 82 of the male terminal housing 8 (a side opposite to an end 81 at the side to engage with the female terminal housing 5), and has a grounding terminal assembling part 61 which is assembled to a grounding terminal 71 provided at the distal end of the grounding line 70.

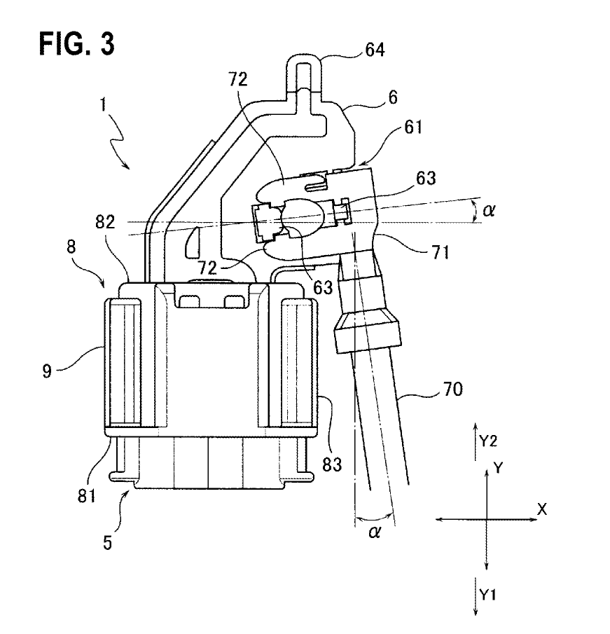

FIG. 3 is a figure which indicates that the grounding line 70 is assembled to the grounding terminal assembling part 61. As shown in FIG. 3, an assembling angle a at which the grounding terminal 71 is assembled to the grounding terminal assembling part 61 is set so that the grounding line 70 extends to be gradually away from a side surface 83 of the male terminal housing 8. Thereby, since it is possible to make the grounding line 70 extend while being sufficiently spaced from the side surface 83 of the male terminal housing 8, even if, for example, the grounding line 70 swings, it can be prevented that the grounding line 70 hits the side surface 83 of the male terminal housing 8.

In this embodiment, a grounding terminal assembling part 61 is formed in the bus bar 6 to make the assembling direction of the grounding terminal 71 substantially perpendicular to the extending direction of the grounding line 70. In other words, the grounding terminal 71 is connected to the core line of the grounding line 70 so that the assembling direction to the grounding terminal assembling part 61 becomes substantially perpendicular to the extending direction of the grounding line 70. The angle between the assembling direction to the grounding terminal assembling part 61 and the extending direction of the grounding line 70 may be substantially a right angle, but also may be an obtuse angle.

Therefore, by inclining the assembling direction of the grounding terminal 71 to the grounding terminal assembling part 61 backward at the assembling angle a from the rightward/leftward direction, it is possible to make the grounding line 70 whose grounding terminal 71 is assembled to the grounding terminal assembling part 61 incline at a predetermined angle (equivalent to the assembling angle a of the grounding terminal 71) from the forward/backward direction. Thereby, it is possible to make the grounding line 70 away from the side surface 83 (a side surface in the rightward/leftward direction) of the male terminal housing 8 toward the extending direction.

The grounding terminal assembling part 61 and the grounding terminal 71 have assembling mechanisms to assemble the counterparts, respectively. The mechanisms are not particularly limited as long as it is possible to stably maintain a connected state while the grounding terminal assembling part 61 and the grounding terminal 71 are electrically connected. In this embodiment, the grounding terminal 71, which is formed into a flat board shape, is provided with a pair of projections 72 that extend to project in the assembling direction to the grounding terminal assembling part 61 (direction substantially perpendicular to the extending direction of the grounding line 70), and the grounding terminal assembling part 61 is provided with a pair of receiving parts 62 that overlaps with the projections 72. Engaging pieces 73 are bridged between two ends in the assembling direction, respectively, in an opening part between the pair of projections 72, and engaged pieces 63 which respectively engage with the engaging pieces 73 are bridged in an opening part between the pair of receiving parts 62. The engaging pieces 73 are bridged to be recessed below the projections 72, and the engaged pieces 63 are bridged to be bulged above the receiving parts 62.

Thereby, by inclining the projecting ends of the projections 72 downward, and inserting the grounding terminal 71 into the grounding terminal assembling part 61 to make the engaging pieces 73 engage with the engaged pieces 63, the grounding terminal assembling part 61 and the grounding terminal 71 can be removably assembled. While the engaging pieces 73 engage with the engaged pieces 63, for example, the grounding terminal 71 and the grounding terminal assembling part 61 may be strongly fixed with screws or the like.

According to the present embodiment in this way, because it is possible to make the grounding line 70, which is assembled to the grounding terminal assembling part 61 of the bus bar 6 through the grounding terminal 71, extend while being sufficiently spaced from the male terminal housing 8, even if the grounding line 70 swings, it can be prevented that the grounding line 70 hits the male terminal housing 8 (or plainly the connector 1). Therefore, it is not necessary, for example, to make the grounding terminal assembling part 61 to greatly project from the bus bar 6 to shift the position of the grounding terminal assembling part 61 to expand the distance between the grounding line 70 and the male terminal housing 8, to avoid the collision of the grounding line 70 and the male terminal housing 8. Thereby, it is possible to downsize the bus bar 6 and the grounding terminal 71 and downsize the connector 1, in response to the assembling angle (inclination angle of the grounding line 70) a of the grounding terminal 71.

The present invention is described above based on the one embodiment as shown in FIGS. 1 to 3, but the embodiment is only an example of the present invention, and the present invention is not limited to this. Therefore, those skilled in the art know that it is possible to implement the present invention in the scope of the spirit of the prevent invention with a modified or changed embodiment, and the modified or changed embodiment surely belong to the scope of claims of the present application.

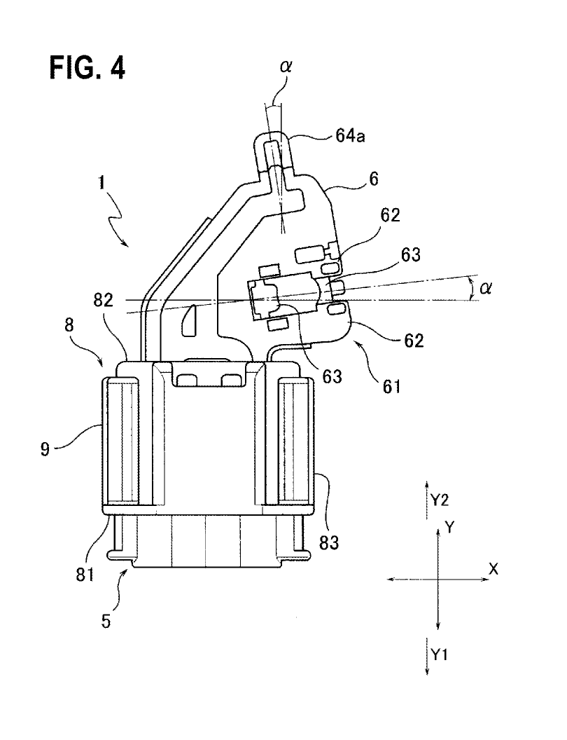

As shown in FIGS. 1 to 3, the bus bar 6 of the present embodiment is formed with a rotation preventing part 64 which prevents a rotation of the connector 1 itself. In this embodiment, the rotation preventing part 64 is formed to extend along the forward/backward direction (backward), but, for example, it is also possible to extend to incline at a predetermined inclination angle from the forward/backward direction like a rotation preventing part 64a shown in FIG. 4. In FIG. 4, it is shown as an example to form the rotation preventing part 64a to incline at an angle corresponding to the assembling angle a of the grounding terminal 71 from the forward/backward direction and extend along the extending direction of the grounding line 70. All of the assembling angle of the grounding terminal 71, and the inclination angles of the grounding line 70 and the rotation preventing part 64a from the forward/backward direction are the same angle a, but they may differ.

If the grounding line 70 extends to be gradually away from the male terminal housing 8, in addition to that the grounding line 70 is inclined at the predetermined inclination angle (assembling angle a of the grounding terminal 71) from the fonvard/backward direction, it is also possible to form the grounding terminal assembling part 61 to be further inclined either upward or downward. In the present embodiment, the assembling direction of the grounding terminal 71 to the grounding terminal assembling part 61 is inclined backward at the assembling angle a from the rightward/leftward direction, but it is also possible, for example, to incline the assembling direction of the grounding terminal to the outside in the rightward/leftward direction at the assembling angle a from the forward/backward direction, if the grounding line 70 extends to be away from the male terminal housing 8. In this case, it is preferable to assume the assembling mechanisms that assemble the grounding terminal to the grounding terminal assembling part along the extending direction of the grounding line. However, in this case, the grounding terminal is connected to the core line of the grounding line so that the assembling direction to the grounding terminal assembling part becomes parallel to the extending direction of the grounding line. In the present embodiment, it is described that the bus bar 6 is to included in the male terminal housing 8 which holds the male terminals, but when the bus bar is included in a female terminal housing which holds female terminals, a similar grounding terminal assembling part may be formed in the bus bar.

What is claimed is:

1. A connector comprising a housing that holds a terminal having a first portion and a second portion, the first portion being embedded in the housing, the second portion being exposed outside the housing,
wherein the second portion of the terminal includes a grounding terminal assembling pan to which a grounding terminal provided at a distal end of a grounding line is assembled, and
an assembling angle at which the grounding terminal is assembled to the to grounding terminal assembling part is set so that the grounding line extends to be gradually away from a side surface of the housing.

2. The connector according to claim 1, wherein an assembling direction of the grounding terminal to the grounding terminal assembling part is substantially perpendicular to an extending direction of the grounding line.
